(19) United States
(12) Patent Application Publication
(10) Pub. No.: US 2007/0300215 A1
(43) Pub. Date: Dec. 27, 2007

(54) Methods, systems, and computer program products for obtaining and utilizing a score indicative of an overall performance effect of a software update on a software host

(76) Inventor: Jeffrey S. Bardsley, Durham, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/474,842

(22) Filed: Jun. 26, 2006

(51) Int. Cl. G06F 9/44

(52) U.S. Cl. 717/168

(57) ABSTRACT

Methods, systems, and computer program products for obtaining and utilizing a score indicative of an overall performance effect of a software update on a software host are disclosed. According to one method, a software update is applied to a software host. Different parameters indicative of performance effects of the software update on the software host are monitored, and corresponding parameter values are obtained. A score is determined based on the parameter values. The score is indicative of the overall performance effect of the software update on the software host. An action relating to the software update is performed based on the score.

### TECHNICAL FIELD

The subject matter described herein relates to evaluating effects of software updates on software hosts. More particularly, the subject matter described herein relates to methods, systems, and computer program products for obtaining and utilizing a score indicative of an overall performance effect of a software update on a software host.

### BACKGROUND ART

When software is developed, it is desirable to test the software in a pre-production environment before executing the software in a post-production or live environment. In order to test software in a pre-production environment, it is desirable to maintain equipment that mimics the post-production environment. For example, if software being developed is security software for a web server, it may be desirable to test the software on each possible web server hardware platform and corresponding software configuration on which the security software will be installed. Performance of the software on each configuration may be monitored to determine whether the software is safe for execution in a post-production environment.

One problem with using a pre-production environment that mimics the post-production environment in which software will be installed is that the number of different hardware platforms and corresponding software configurations that must be tested to thoroughly evaluate the software makes maintaining such an environment cost prohibitive. Large software development companies may maintain labs that include representative samples of a post-production environment. However, even large companies cannot mimic every possible configuration on which software will be installed. Small companies may not be able to maintain more than a few machines on which the software will be tested. The problem is multiplied when the number of updates for a particular software package increases.

Testing the effects of software on performance of other software and the associated hardware platforms is essential to development of software that is safe for a post-production environment. However, as stated above, mimicking the entire post-production environment is impractical. Accordingly, there exists a need for improved methods, systems, and computer program products for obtaining and utilizing a score indicative of an overall performance effect of a software update on a software host.

### SUMMARY

The subject matter described herein includes methods, systems, and computer program products for obtaining and utilizing a score indicative of overall performance effects of a software update on a software host. According to one method, a software update is applied to a software host. A plurality of different parameters indicative of performance effects of the software update on the software host is monitored, and corresponding parameter values are obtained. A score indicative of an overall performance effect of the software update on the software host is generated based on the parameter values. An action is performed related to the software update based on the score.

The subject matter described herein may be implemented using a computer program product comprising computer executable instructions embodied in a computer readable medium. Exemplary computer readable media suitable for implementing the subject matter described herein include chip memory devices, disk memory devices, programmable logic devices, application specific integrated circuits, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram of a system for obtaining and utilizing a score indicative of overall performance effects of a software update on a software host according to an embodiment of the subject matter described herein;

FIG. 2 is a flow chart illustrating an exemplary process from a software host perspective for obtaining and utilizing a score indicative of overall performance effects of a software update on a software host according to an embodiment of the subject matter described herein;

FIGS. 3A and 3B are a flow chart illustrating an exemplary process from a software host perspective for obtaining and utilizing a score indicative of overall performance effects of a software update on a software host according to an embodiment of the subject matter described herein;

FIG. 4 is a flow chart illustrating an exemplary process from a service provider perspective for obtaining and utilizing a score indicative of overall performance effects of a software update and a software host according to an embodiment of the subject matter described herein;

FIGS. 5A and 5B are a flow chart illustrating an exemplary process from an update provider perspective for obtaining and utilizing a score indicative of overall performance effects of a software update on a software host according to an embodiment of the subject matter described herein; and

FIG. 6 is a block diagram illustrating an alternate implementation of system for obtaining and utilizing a score indicative of overall performance effects of a software update on a software host according to an embodiment of the subject matter described herein.

### DETAILED DESCRIPTION OF THE INVENTION

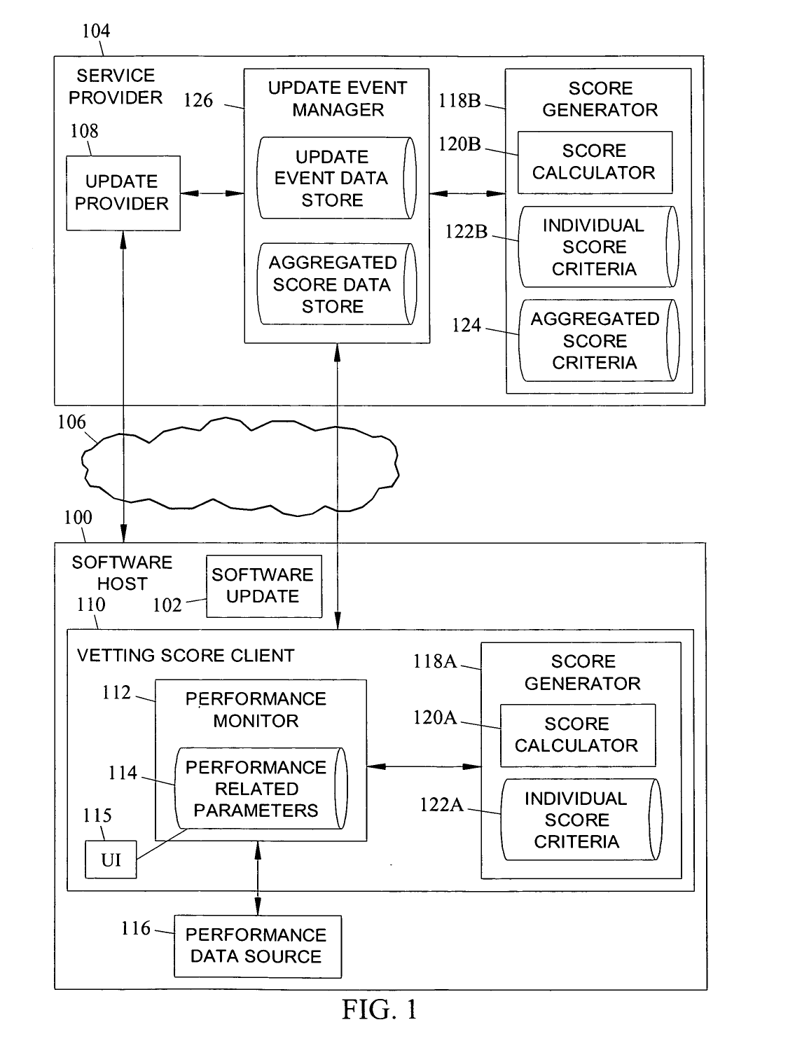

FIG. 1 is a block diagram illustrating a system for performance effects of a software update on a software host according to an embodiment of the subject matter described herein. As used herein, the term “software update” refers to any software that may be installed on a software host, including software for which a prior version exists on the software host and software for which a prior version does not exist on the software host. The term “software host” refers to a hardware platform and its associated software configuration on which the software update is installed. Referring to FIG. 1, a software host 100 receives a software update 102 from a service provider 104 via network 106. An update provider 108 maintained by service provider 104 may provide the software update to software host 100. In an alternate implementation, a user may obtain a storage medium containing software update 102 and may install software update 102 on software host 100 by inserting the storage medium, such as a magnetic disk, an optical disk, or a memory device, into a reader local to software host 100. Update provider 108 may be any suitable system for delivering software update 102 to software host 100. One example of a commercially available update provider is the Windows Update Service. Other examples of suitable update providers include third party patch management systems, such as those provided by Ospware.

Service provider 104 may distribute software updates to software hosts and may assign a unique identifier to each software update. The identifier may be any suitable identifier that uniquely identifies a software update. Examples of update identifiers that may be used include an application name for new applications or an application name plus a version number for upgrades to existing applications. Software hosts may also be uniquely identified by hostname or IP address. The unique identifiers for software updates and software hosts may be recorded by update provider 108 and used in update event records, which will be described in more detail below.

In order to monitor the performance effects of software update 102 on software host 100, a vetting score client 110 may reside on software host 100. Vetting score client 110 may be downloaded along with software update 102. Alternatively, vetting score client 110 may be obtained from a storage medium associated with software update 102 or from a separate download or storage medium. In alternate implementations, vetting score client 110 may be installed on a centralized platform maintained by the software update provider or by a third party.

Vetting score client 110 may collect identification information regarding the software update and the software host. This identification information may include any of the software update or software host identifying information described above. In order to collect this information, vetting score client 110 may include a watchdog function that monitors system logs to determine whether software has been installed. Examples of system logs that may be monitored include the UNIX SYSLOG and the Windows Event View Application/System logs. An example of a watchdog application that may be used to monitor these logs is the SWATCH program available at http://swatch.sourceforge.net/.

Vetting score client 110 may monitor a plurality of different performance-related parameters for the software host and determine point values by comparing each monitored performance parameter to a corresponding scoring rule that converts each monitored performance parameter into a point value. The point values may be combined into a score indicative of an overall performance of the effect of software update 102 on software host 100. Vetting score client 110 may also create and store an update event record, which creates an association between the software update, the host, and the score.

In order to monitor performance parameters, a performance monitor 112 may obtain performance-related parameters 114 to be monitored. Exemplary performance-related parameters that may be monitored include CPU usage, communications availability, trouble ticket generation, and availability of other applications on software host 100. Additional examples of performance-related parameters will be described below. In one example, vetting score client 110 may include a user interface 115 for allowing the user to select or otherwise indicate performance-related parameters to be monitored. In an alternate example, performance monitor 112 may be adapted to download performance-related parameters to be monitored from service provider 104 or from a standards organization. In yet another alternate example, performance monitor 112 and/or software update 102 may be preconfigured with performance-related parameters to be monitored.

Performance monitor 112 may obtain values for the performance-related parameters from a performance data source 116. Performance data source 116 may include local and/or remote utilities for monitoring performance of software host 100. Examples of local performance data sources include command line utilities available to the operating system of software host 100. Examples of remote data sources include the output of the network scanning tools, the output of a service level agreement server that continuously loads a web page provided by a software host, assuming that software host 100 is a web server, information from software update customer service representatives, and information from software help desk ticketing systems.

Other examples of local performance data sources include Microsoft Event Viewer Log and Task Manager. For UNIX- and LINUX-based systems, SYSLOG information logs may be used as performance data source 116. Another example of a Microsoft-specific performance data source is the NETSTAT command line interface. In yet another example, software update 102 may include its own built in performance monitoring code that monitors the effects of installation of software update 102 on software host 100. In yet another example, the application or update being installed may include a plug in for monitoring performance effects of the update on the software host.

Specific examples of remote performance data sources that may be used include output from network port scanners that indicate the availability of communication ports, information from a customer service representative, and help desk ticketing system information.

In general, performance data that is monitored may include operational and business function data that can be used to calculate a score. Some examples of performance data include CPU usage of software host 100, network connectivity between software host 100 and a target host, the number of help desk tickets open for software host 100, the availability of an application, the availability of network ports. The following examples are examples of system commands that may be executed on software host 100 and the corresponding performance data:

### PERFORMANCE DATA EXAMPLE 1

The “NETSTAT” command output shows connections:

Active Connections:

| Proto | Local Address | Foreign Address | State |
|---|---|---|---|
| TCP | 0.0.0.0:135 | 0.0.0.0:0 | LISTENING |
| TCP | 0.0.0.0:445 | 0.0.0.0:0 | LISTENING |
| TCP | 0.0.0.0:58343 | 0.0.0.0:0 | LISTENING |
| TCP | 1.2.3.5:1173 | 1.2.3.4:443 | ESTABLISHED |

### PERFORMANCE DATA EXAMPLE 2

The “NET START” command output shows what applications are running: These Windows services are started:
Application Layer Gateway Service
Automatic Updates
Cisco Systems, Inc. VPN Service
Cryptographic Services
DCOM Server Process Launcher

The first example above is the output of a NETSTAT command on a Windows system. In the illustrated example, the NETSTAT command indicates that three TCP applications are listening on three different ports of a device and that there is an active SSL connection with another device. Such output may be used to evaluate the communication availability impact of software update 102. In the second performance example above, the output of the NET START command may be used to indicate what applications are available on software host 100.

Performance monitor 112 may monitor any performance-related parameters 114 and generate corresponding performance values. Examples of actions that may be performed by performance monitor 112 in generating the parameter values include:
Watch the CPU usage for 24 hours by using Task Manager.
Count the number of helpdesk tickets opened for software host 100 for 48 hours.
Check for the availability of port 80 for 24 hours by executing a script that uses the NETSTAT command.
Check for the instantiation of the inetinfo.exe by a script that uses the output of Task Manager.
Check the connectivity between the software host 100 and a target server located at the IP address of 1.2.3.4.

The above-listed examples are intended to be illustrative of actions that may be performed by performance monitor 112 in generating the parameter values. However, performance monitor 112 is not limited to these specific actions. Any actions for collecting values that indicate the effect of software update 102 on software host 100 are intended to be within the scope of the subject matter described herein.

Returning to FIG. 1, once performance parameter values are collected, a score indicative of the overall performance effect of software update 102 on software host 100 is calculated. In one example, the score may be calculated using score generator 118A local to software host 100. In the illustrated example, score generator 118A includes a score calculator 120A for calculating the score by comparing performance data values obtained from performance data source 116 to individual score criteria 122A. In alternate example, the score may be generated by a score generator 118B remote from software host 100, an associated score calculator 120B, and individual score criteria 122B. Score generator 118B may also compute an aggregate score indicating the effects of software update 102 on multiple different software hosts by comparing individual scores to aggregated score criteria 124.

In one implementation, a score may be a representation of post-installation performance of software host 100 in relation to software update 102. An individual score may represent a post-installation performance of a single software host, such as software host 100. An aggregated score may be representative of post-installation performance of multiple software hosts. The score value may be dependent upon a number of metrics used in score criteria 122A. For example, the score may be a number on a scale 1 to 10.

As stated above, score criteria 122A or 122B may include metrics or tolerances for results collected by performance monitor 112. Each measurement may also include a point value that is used to compute the score. The following table illustrates an example of individual score criteria that may be used to generate an individual score relating to the performance of effects of software update 102 on software host 100.

TABLE 1
Individual Score Criteria

| | Points |
|---|---|
| Tolerances | Scored |
| CPU % average <35 | 3 |
| CPU % average 36–75 | 2 |
| CPU % average >76 | 1 |
| Port 80 Available <25% of time | 0 |
| Port 80 Available 26–50% of time | 1 |
| Port 80 Available 51–85% of time | 2 |
| Port 80 Available >85% of time | 3 |
| The # of help desk tickets <5 | 3 |
| The # of help desk tickets 6–10 | 2 |
| The # of help desk tickets >10 | 1 |

In Table 1, the left-hand column lists performance rules or criteria to which the performance data values collected by performance monitor 112 are compared. The right-hand column lists corresponding point values for each rule. In the illustrated example, performance rules for CPU usage, port availability, and number of help desk tickets are illustrated. Measured performance data values may be compared to the rules in Table 1 and corresponding points are generated. The points for each performance data value may be then combined to generate a total point score indicative of the overall performance effect of the installation of software update 102 on host 100. For example, if the CPU usage is 20%, the availability of port 80 is 90%, and no help desk tickets are generated when a software update is installed on a software host, the score may be 3+3+3=9.

As discussed above, another aspect of the subject matter described herein may include aggregating performance scores from installations of software update 102 on multiple difference software hosts. Such aggregation may be performed by score generator 118B comparing individual scores and information regarding the diversity of software host test configurations to aggregated score criteria 124. Table 2 shown below illustrates an example of aggregated score criteria that may be used to generate an aggregated score.

TABLE 2
Aggregated Score Criteria

| Metric | Points Scored |
|---|---|
| # of different CPUs 1–2 | 1 |
| # of different CPUs 3–4 | 2 |
| # of different CPUs >5 | 3 |
| # of hardware types 1–2 | 1 |
| # of hardware types 3–4 | 2 |
| # of hardware types >5 | 3 |
| # of different OSs 1–2 | 1 |
| # of different OSs 3–4 | 2 |
| # of different OSs >5 | 3 |
| Average of Individual Vetting | 1 |
| Scores <4 | |
| Average of Individual Vetting | 2 |
| Scores 5–8 | |
| Average of Individual Vetting | 3 |
| Scores >8 | |

In Table 2, the left-hand column includes aggregated score criteria or rules to which individual scores and software host test configuration information are compared. The right-hand column includes corresponding point values. The point values may be combined to generate a total aggregate score for a software update. In one example, a software update may be tested on 3 different CPUs on 3 different hardware platforms with 2 different operating systems. The average individual score for these tests may be 7. Using the data in Table 2, the aggregate score will be 2+2+1+2=7. Because an aggregate score can be based on performance effects of a software update on multiple different software hosts, the aggregate score may provide a universal or platform-neutral indication of the effect of a software update on a software host. The aggregate score and/or the individual score may be used in performing an action with regard to the software update, such as maintaining the software update on a software host in response to the score being greater than a threshold, removing the software update from the software host in response to the score being less than the threshold, or installing the software update on like devices in response to the score being greater than the threshold. Another example of an action that may be performed when the score exceeds a threshold value is to allow installation of the next software update in a sequence of software updates.

Returning to FIG. 1, service provider 104 may include an update event manager 126 for performing an action relating to the score generated by score generator 118A or 118B. The action may include associating the score with configuration information regarding software host 100 and identification information regarding software update 102, thereby creating a relationship between the score, the software update, and the software host. The association may be in the form of an update event record. Table 3 shown below illustrates exemplary data that may be included in an update event record. Such an update event record may be created by update event manager 126 or by vetting score client 110.

TABLE 3
Update Event Record

| Update | Software | Software | | |
|---|---|---|---|---|
| Event | Host | Update | Individual | Performance |
| Record ID | Identifier | Identifier | Vetting Score | Data |
| 12345 | 1.1.1.1 | KB911456 | xxxxxxx | xxxxxxx |
| 123456 | 2.2.2.2 | Java Plugin # 4 | xxxxxxx | xxxxxxx |

In Table 3, the left-most field in the update event record includes an identifier for the record. The second field includes a software host identifier, which identifies the software host. In the illustrated example, the software host identifier is an IP address. This identifier may be used to locate configuration information for the software host in another table that stores the corresponding configuration information, such as processor speed, operating system version, other applications being executed, and/or vendor/manufacturer/model number information. The next field in Table 3 identifies the software update. The next field identifies the individual score generated with regard to the software update. The right-most field indicates the performance data that was monitored.

As stated above, actions that may be performed relating to the individual or aggregate score may include removing software update 102 from software host 100 if the score is below a predetermined threshold value or maintaining software update 102 on software host 100 if the score is greater than or equal to the threshold value. Such action may be performed automatically by vetting score client 110 or by update provider 108. Another action that be performed based on the score may include installing software update 102 on devices like software host 100 if the score is above the threshold. This action may be automatically performed by update provider 108. Alternatively, the installation, maintenance, or removal of software update 102 based on the score may be performed manually by a user.

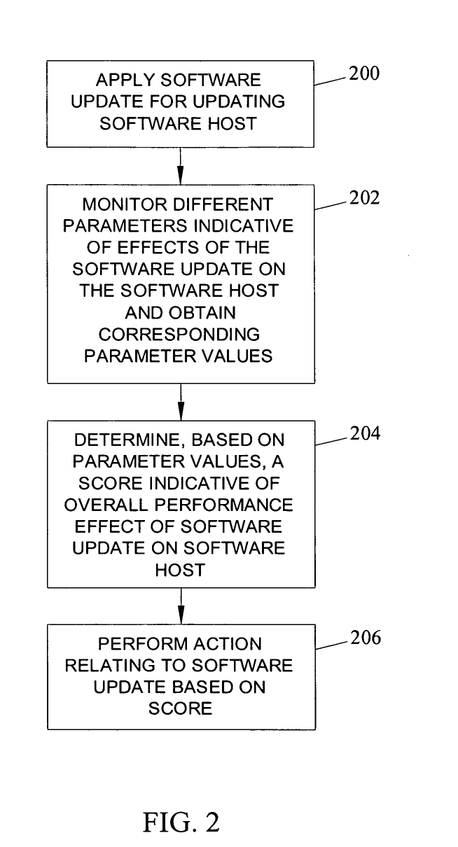

FIG. 2 is a flow chart illustrating an exemplary process from the perspective of software host 100 for obtaining and utilizing a score indicative of overall performance effects of a software update on a software host according to an embodiment of the subject matter described herein. Referring to FIG. 2, in block 200 a software update is applied to a software host. As stated above, the software update may be downloaded over a network or may be installed on the software host using a readable storage medium, such as a disk or a memory device.

In block 202, different parameters indicative of effects of the software update on the software host are monitored and corresponding parameter values are obtained. Examples of performance parameters monitored include any of the parameters discussed above. In block 204, a score is determined based on the parameter values. The score is indicative of the overall performance effect of the software update on the software host. In block 206, an action relating to the software update is performed based on the score. As stated above, actions may include communicating the score to service provider 104, maintaining software update 102 on software host 100, removing software update 102 from software host 100, or installing software update 102 on like software hosts.

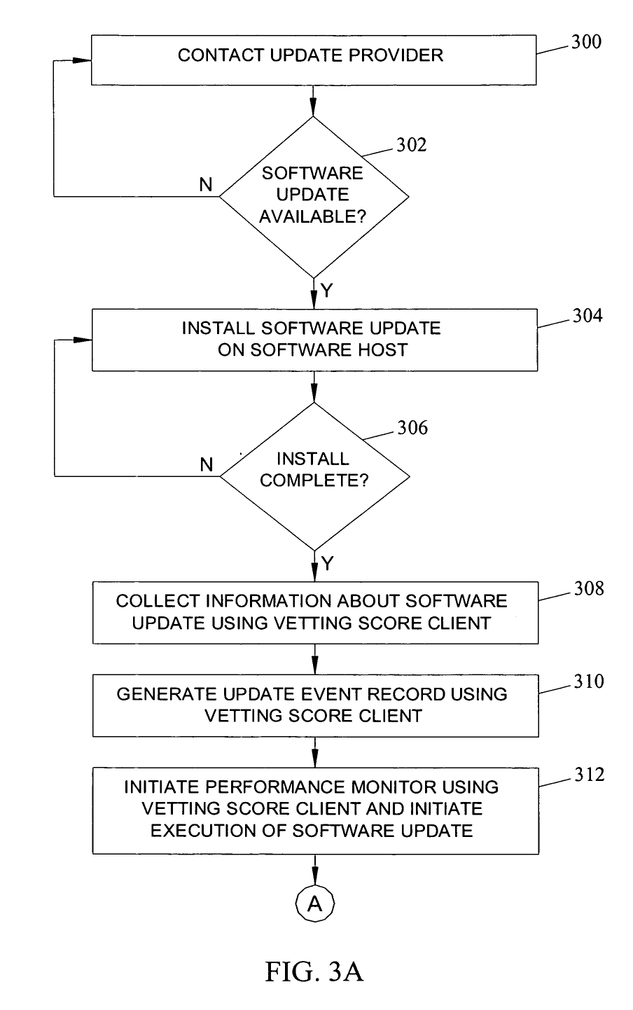

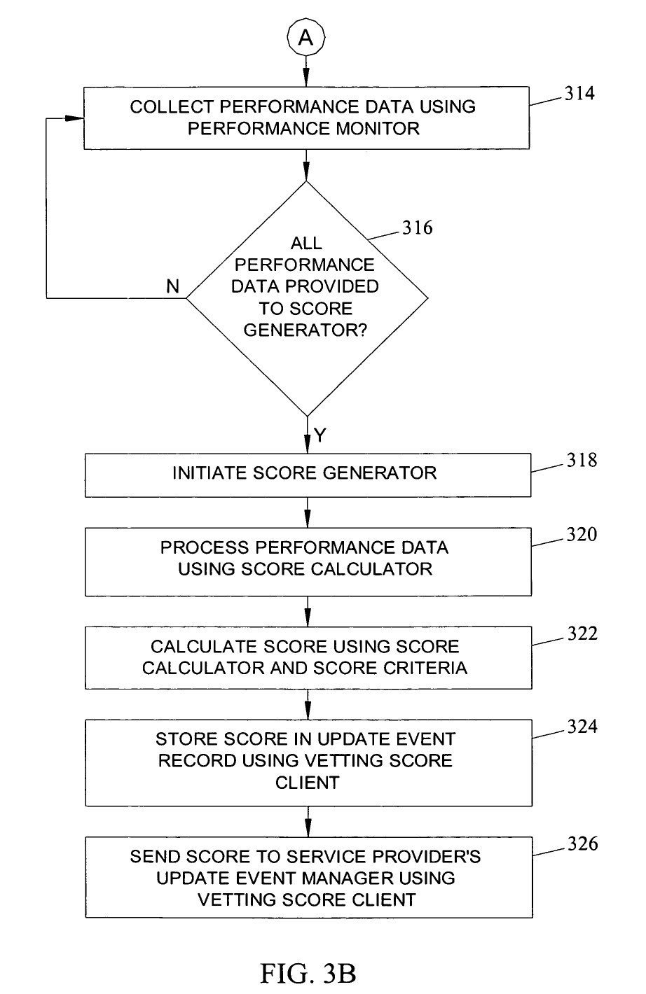

FIGS. 3A and 3B are a flow chart illustrating in detail a process from the perspective of software host 100 for generating a score indicative of an overall performance effect of software update 102 on software host 100. Referring to FIG. 3, in block 300, the software host 100 contacts update provider 108 for the availability of software updates. In block 302, it is determined whether a software update is available. If a software update is not available, block 300 may be repeated at periodic or aperiodic intervals. If a software update is available, control proceeds to block 304 where the software update is installed on software host 100. In block 306, it is determined whether the install is complete. It the install is not complete, installation is continued until the install is completed.

Once the install is complete, control proceeds to block 308 where vetting score client 110 collects information about the software update. Exemplary information that may be collected includes identification information regarding the software update and configuration information regarding the software host. In block 310, vetting score client 110 may generate an update event record for storing performance data, such as the performance parameters monitored, the parameter values, and the score, relating to the software host. In block 312, vetting score client 110 initiates performance monitor 112 to monitor performance-related parameters regarding the effect of software update on software host 100 and initiates execution of the software update.

Referring to FIG. 3B, in block 314, performance monitor 112 collects performance data. Examples of data that may be collected are described above. Once the performance data is collected, control proceeds to block 316 where performance monitor 112 provides the performance data to score generator 118A or 118B. Once the process of providing the score data to score generator 118A or 118B is complete, control proceeds to block 318 where score generator 118A or 118B is initiated. In block 320, score calculator 120A or 120B processes the performance data. In block 322, score calculator 120A or 120B computes the score by comparing the score to the score criteria.

In block 324, vetting score client 110 stores the score in the update event record. In block 326, vetting score client 110 communicates the update event record to update event manager 126.

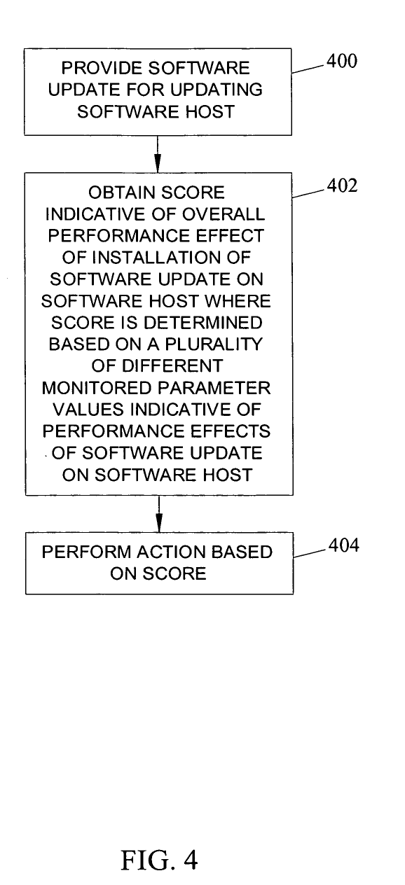

FIG. 4 is a flow chart illustrating an exemplary process from the perspective of service provider 104 for obtaining and utilizing a score indicative of an overall performance effect of installation of a software update on a software host according to an embodiment of the subject matter described herein. Referring to FIG. 4, in block 400, a software update for updating a software host is provided. The software update may be provided via a network or via a storage medium, such as a disk or memory device. In block 402, service provider 104 obtains a score indicative of the overall performance effect of installation of the software update on the software host. The score may be determined based on a plurality of different monitored parameter values indicative of performance effects of the software update on the software host. Obtaining the score may include calculating the score using score generator 118B local to service provider 104 or receiving a score calculated by score generator 118A local to software host 100.

In block 404, service provider 104 performs an action based on the score. Performing an action may include generating the update event record, computing an aggregate score, installing the software update on devices similar to software host 100, maintaining the software update or software host 100, or removing the software update from software host 100.

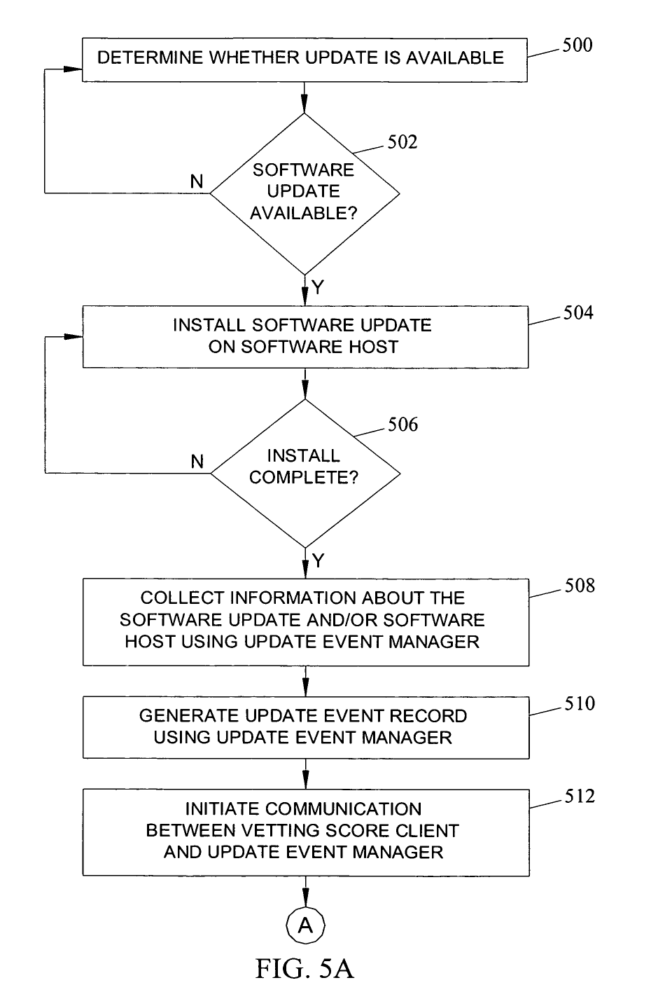

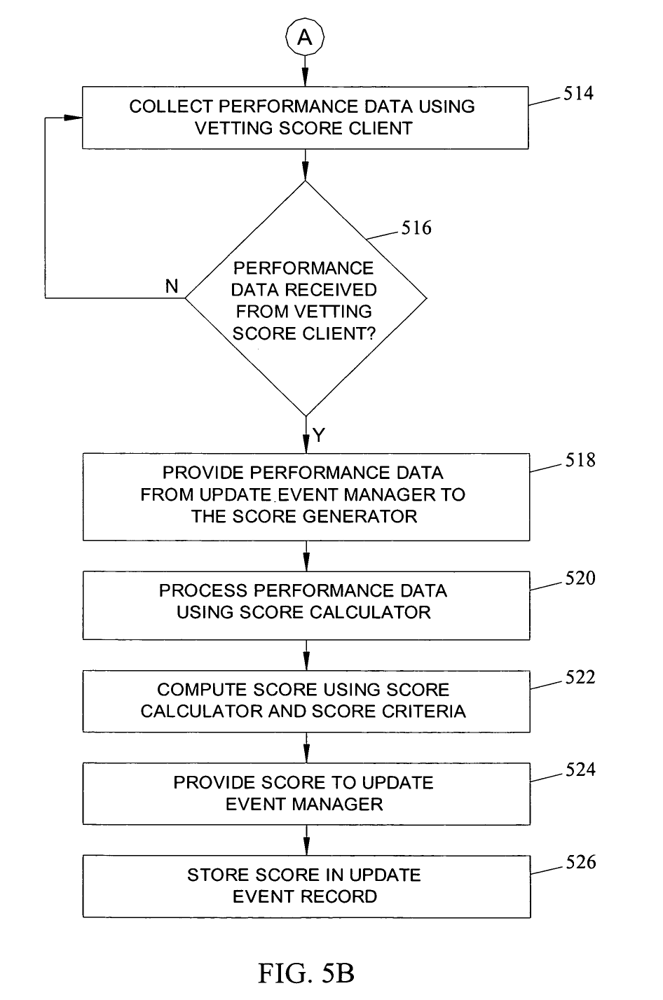

FIGS. 5A and 5B are a flow chart illustrating an exemplary detailed process from a service provider perspective for obtaining and utilizing a score indicative of overall performance effects of installation of a software update on a software host according to an embodiment of the subject matter described herein. Referring to FIG. 5A, in blocks 500 and 502, update provider 108 determines whether the update is available. If the update is available, control proceeds to block 504 where the update is installed on the host. In block 506, it is determined whether the installation is complete.

Once the installation is complete, control proceeds to block 508 where update event manager 126 collects information about the software update and/or software host 100. Such information may include identification information regarding the software update and configuration information regarding software host 100. In block 510, update event manager 126 generates an update event record. In block 512, update event manager 126 initiates communication with vetting score client 110.

Referring to FIG. 5B, in block 514, vetting score client 110 obtains performance data values. In block 516, update event manager 126 determines whether it has received the performance data from vetting score client 110. Once the performance data has been obtained, control proceeds to block 518 where update event manager 126 provides performance data to score generator 118B.

In block 520, score calculator 120B processes the score data. In block 522, score calculator 120B compares the performance data to score criteria 122B to generate an individual score relating to the performance effect of installing software update 102 on software host 100. In block 524, the computed score is provided to update event manager 126. In block 526, update event manager 126 stores the score in the update event record.

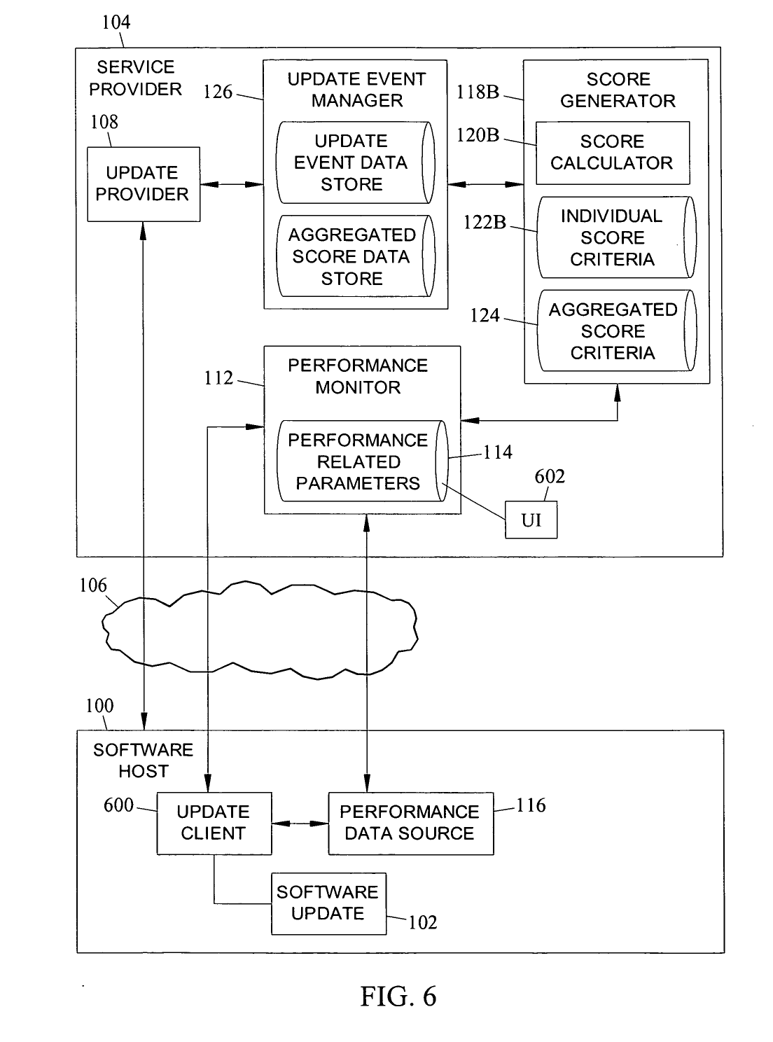

As stated above, the components for generating the score and collecting performance data may be located locally or remotely with regard to software host 100. FIG. 6 illustrates an alternate embodiment of the subject matter described herein where performance monitor 112 and score generator 118B are each located remotely from software host 100. Referring to FIG. 6, software host 100 includes update client 600 for installing a software update 102 received from update provider 108. Update client 600 may also provide information regarding software update 102 to performance monitor 112, which is local to service provider 104 and remote from software host 100. Examples of data that may be provided include configuration information regarding software host 100 and identification information regarding software update 102. Performance data source 116 may include any of the above-described utilities that provide performance data values. Performance monitor 112 may collect data values of interest based on performance-related parameters 114. A user interface 602 may allow a user to select performance-related parameters to be monitored. Score generator 118B may calculate individual and aggregated scores as described above. Event manager 126 may generate the update event record as described above.

According to one aspect, the subject matter described herein includes a system for obtaining and utilizing a score indicative of an overall performance effect of a software update on a software host. The system may include means for applying a software update for updating a software host. For example, update provider 108 illustrated in FIG. 1 may provide software update for updating software host 100. Alternatively, software update 102 may be installed using a storage medium local to software host 100. The system may further include means for monitoring a plurality of different parameters indicative of performance effects of the software update on the software host and obtaining corresponding parameter values. For example, performance monitor 112 may monitor performance data generated by performance data source 116 based on performance-related parameters 114. Performance monitor 112 may be local to or remote from software host 100. The system may further include means for determining, based on the parameter values, a score indicative of an overall performance effect of the software update on the software host. For example, score generator 118A or 118B may generate a score based on parameter values collected by performance monitor 112. The system may further include means for performing an action related to the software update based on the score. For example, update provider 108 may make a determination as to whether or not to install software update on software host 100 or other like devices based on the score. In another example, update event manager 126 may update or generate an aggregate score for evaluating the performance of software update 102 on multiple software hosts in response to receiving individual scores from different software hosts.

In an alternate implementation from an update or service provider's perspective, a system for obtaining and utilizing a score indicative of an overall performance effect of a software update on a software host may include means for providing a software update for updating a software host. For example, update provider 108 illustrated in FIG. 1 may provide software update 102 to software host 100. In another example, software update 102 may be installed by a user using a storage medium local to software host 100. The system may further include means for obtaining a score indicate of an overall performance effect of the software update on the software host, where the score is determined based on a plurality of different monitored parameter values indicative of performance effects of the software update on the software host. For example, in FIG. 1, score generator 118B may obtain parameter values from performance monitor 112 and compute the score local to service provider 104. In an alternate example, score generator 18A local to software host 100 may generate the score and provide the score to service provider 104. In yet another alternate example, illustrated in FIG. 6, performance monitor 112 local to service provider 104 may obtain the performance parameter values from performance data source 116, and score generator 118B local to service provider 104 may generate the score based on the parameter values. The system may further include means for performing an action relating to the score. In one example, update provider 108 may remove software update 102 from software host 100 if the score is below a predetermined threshold. In another example, update provider 108 may maintain software update 102 on software update 102 if the score is above a predetermined threshold. In yet another example, update provider 108 may install software update 102 on devices like software host 100 if the score is above the threshold.

It will be understood that various details of the invention may be changed without departing from the scope of the invention. Furthermore, the foregoing description is for the purpose of illustration only, and not for the purpose of limitation.

What is claimed is:

1. A method for obtaining and utilizing a score indicative of an overall performance effect of a software update on a software host, the method comprising:
applying a software update for updating a software host;
monitoring a plurality of different parameters indicative of performance effects of the software update on the software host and obtaining corresponding parameter values;
determining, based on the parameter values, a score indicative of an overall performance effect of the software update on the software host; and
performing an action related to the software update based on the score.

2. The method of claim 1 wherein applying a software update includes updating existing software residing on the software host.

3. The method of claim 1 wherein applying a software update includes installing computer software on the software host for which no previous version exists on the software host.

4. The method of claim 1 wherein monitoring a plurality of different parameters includes monitoring at least two of CPU usage, communication availability, trouble ticket generation, and availability of other applications on the software host during execution of the software update.

5. The method of claim 1 wherein monitoring a plurality of different parameters includes providing an interface on the software host for allowing a user to select the parameters and monitoring the parameters selected by the user.

6. The method of claim 1 wherein monitoring a plurality of different parameters includes providing a set of customized parameters to be monitored for the software update.

7. The method of claim 1 wherein monitoring a plurality of different parameters includes downloading the parameters to be monitored from at least one of a service provider and a standards organization.

8. The method of claim 1 wherein determining a score includes generating a score using a score generator executing on the software host.

9. The method of claim 1 wherein determining a score includes obtaining the parameter values from the software host and generating the score using a score generator remote from the software host.

10. The method of claim 1 wherein determining a score includes comparing each parameter value to a corresponding scoring rule that converts each parameter value into a point value and combining the point values generated for the different parameter values to produce the score.

11. The method of claim 1 wherein performing an action includes maintaining the software update on the software host in response to the score having a predetermined value.

12. The method of claim 1 wherein performing an action includes removing the software update from the software host in response to the score having a predetermined value.

13. The method of claim 1 wherein performing an action includes associating the score with identification information regarding the software update and configuration information regarding the software host and thereby creating a relationship between the score, the software update, and the software host.

14. The method of claim 13 wherein performing an action includes communicating the score and the associated configuration and identification information to a service provider.

15. The method of claim 1 wherein performing an action includes installing the software update on devices having configurations similar to that of the software host in response to the score having a predetermined value.

16. A method for obtaining and utilizing a score indicative of an overall performance effect of a software update on a software host, the method comprising:
providing a software update for updating a software host;
obtaining a score indicative of an overall performance effect of the software update on the software host, the score being determined based on a plurality of different monitored parameter values indicative of performance effects of the software update on the software host; and
performing an action relating to the score.

17. The method of claim 16 wherein providing a software update includes providing a software update for which a prior version exists on a software host.

18. The method of claim 16 wherein providing a software update includes providing a software update for which a prior version does not exist on the software host.

19. The method of claim 16 wherein obtaining a score includes calculating a score using a score generator local to a software update provider based on parameter values received from the software host.

20. The method of claim 19 wherein calculating a score includes comparing each of the parameter values to a corresponding scoring rule that converts each parameter value into a point value and combining the point values generated for the different parameter values to produce the score.

21. The method of claim 16 wherein obtaining a score includes receiving a score from a score generator located on the software host.

22. The method of claim 16 wherein performing an action includes associating the score with configuration information regarding the software host and identification information regarding the software update and thereby creating a relationship between the score, the software update, and the software host.

23. The method of claim 16 wherein performing an action includes aggregating the score with scores generated for applying the software update to other software hosts.

24. The method of claim 23 wherein aggregating the score includes:
computing an average score based on individual scores generated for applying the software update to the other software hosts;
assigning a point value to the average score;
assigning point values to information regarding diversity of software host configurations on which the software update was tested; and
combining the point values to produce the aggregate score.

25. A system for evaluating an overall performance effect of a software update on a software host, the system comprising:
a performance monitor for monitoring a plurality of different parameters indicative of performance effects of the software update on the software host; and
a score generator for determining, based on the parameter values, a score indicative of an overall performance effect of the software update on the software host.

26. The system of claim 25 wherein the performance monitor includes a user interface for receiving user selections regarding the parameters to be monitored.

27. The system of claim 25 wherein the performance monitor is preconfigured with parameters to be monitored for the software update.

28. The system of claim 25 wherein the performance monitor is adapted to download parameters to be monitored from at least one of a service provider and a standards organization.

29. The system of claim 25 wherein the score generator is local to the software host.

30. The system of claim 25 wherein the score generator is remote from the software host.

31. The system of claim 25 wherein the score generator is adapted to generate the score by comparing each parameter value to a corresponding scoring rule that converts each parameter value into a point value and combining the point values generated for the different parameter values to produce the score.

32. The system of 25 wherein the score generator is adapted to aggregate the score generated for the software host with scores generated for applying the software update to other software hosts.

33. The system of claim 32 wherein the score generator is adapted to aggregate the score by:
computing an average score based on individual scores generated for applying the software update to the other software hosts;
assigning a point value to the average score;
assigning point values to information regarding diversity of software host configurations on which the software update was tested; and
combining the point values to produce the aggregate score.

34. The system of claim 25 comprising an update event manager for associating the score with configuration information for the software host and identification information for the software update and thereby creating a relationship between the score, the software update, and the software host.

35. A system for obtaining and utilizing a score indicative of an overall performance effect of a software update on a software host, the system comprising:
means for applying a software update for updating a software host;
means for monitoring a plurality of different parameters indicative of performance effects of the software update on the software host and obtaining corresponding parameter values;
means for determining, based on the parameter values, a score indicative of an overall performance effect of the software update on the software host; and
means for performing an action related to the software update based on the score.

36. A system for obtaining and utilizing a score indicative of an overall performance effect of a software update on a software host, the system comprising:
means for providing a software update for updating a software host;
means for obtaining a score indicative of an overall performance effect of the software update on the software host, the score being determined based on a plurality of different monitored parameter values indicative of performance effects of the software update on the software host; and
means for performing an action relating to the score.

37. A computer program product comprising computer executable instruction embodied into the computer readable medium for performing steps comprising:
applying a software update for updating a software host;
monitoring a plurality of different parameters indicative of performance effects of the software update on the software host and obtaining corresponding parameter values;
determining, based on the parameter values, a score indicative of an overall performance effect of the software update on the software host; and
performing an action related to the software update based on the score.

38. A computer program product comprising computer executable instructions embodied in a computer readable medium for performing steps comprising:
providing a software update for updating a software host;
obtaining a score indicative of an overall performance effect of the software update on the software host, the score being determined based on a plurality of different monitored parameter values indicative of performance effects of the software update on the software host; and
performing an action relating to the score.
